(19) United States
(12) Patent Application Publication
(10) Pub. No.: US 2008/0132661 A1
(43) Pub. Date: Jun. 5, 2008

(54) Catalyst System for the Polymerization of Olefins

(75) Inventors: Vincenzo Busico, Napoli (IT); Mauro Guardasole, Mignano Montelungo (IT); Roberta Cipullo, Napoli (IT); Luigi Resconi, Ferrara (IT); Giampiero Morini, Padova (IT)

Correspondence Address: Basell USA Inc., Delaware Corporate Center II, 2 Righter Parkway, Suite #300, Wilmington, DE, 19803, US

(73) Assignee: BASELL POLYOLEFINE GmbH, WESSELING (DE)

(21) Appl. No.: 10/547,658

(22) PCT Filed: Feb. 24, 2004
(86) PCT No.: PCT/EP04/01847

§ 371 Date: Nov. 13, 2006

Related U.S. Application Data
(60) Provisional application No. 60/454,484, filed on Mar. 13, 2003.

(30) Foreign Application Priority Data
Mar. 6, 2003 (EP) 03075656.3

(51) Int. Cl. C08F 4/52; C07F 5/02; C07F 7/00; C07F 17/00

(52) U.S. Cl. 526/198; 564/8; 556/51

(57) ABSTRACT

A heterogeneous catalyst component obtainable by contacting: (a) a solid Lewis acid of formula MR¹ₐ wherein M is a metal of group 1-12 of the Periodic Table of the Elements; R¹ is a fluorine, chlorine, bromine or iodine atom; and a is equal to the valence of the metal M; and (b) at least one ionic compound of formula (I) [((T)ₚR²)ₙM^{I}(R³)ₘ]⁻[D]⁺(I) wherein: M^{I} is an element belonging to group 13 of the Periodic Table of the Elements; R³, equal to or different from each other, are halogen atoms, halogenated C₆-C₂₀ aryl and halogenated C₇-C₂₀ alkylaryl groups; two R¹ groups, can also form with the element M one condensed ring; R², equal to or different from each other, are hydrocarbon groups; T is a Lewis base in its neutral form; n ranges from 1 to 4; m ranges from 0 to 3; and m+n=4; p ranges from 1 to 10; and [D]⁺ is a monovalent cation.

The present invention relates to a heterogeneous catalyst component containing a compound of an element of group 13 of the Periodic Table of the Elements such as boron, catalyst systems for the polymerization of olefins comprising such compound, and a process for the polymerization of olefins carried out in the presence of the above catalyst system.

Compounds of elements of group 13 of the Periodic Table of the Elements, such as boron compounds, are well known cocatalysts for single-site catalysts such as metallocene-based catalysts. An advantage of these cocatalysts is that they can be used in equimolar ratio with respect to catalysts whereas, when alumoxanes are used, large excess is needed.

A drawback of the heterogeneous catalyst systems including compounds containing an element of group 13 of the Periodic Table of the Elements such as boron consists in the fact that, when the active species are adsorbed on a carrier, they are only weakly bound to the surface of the latter. Therefore, they can be desorpted during polymerization with a consequent increasing of fouling in the reactor. Several systems for tethering both the catalyst and the boron cocatalyst on the surface of the support have been proposed. For example, in U.S. Pat. No. 5,869,723 the compound [HNMe₂Ph]⁺[(C₆FS)₃B(C₆F₄—RCl)]⁻ where RCl═SiCl₃, SiMe₃Cl, (CH₂)_{g}SiMe₂Cl is reacted with partially hydroxylated silica to form a heterogeneous cocatalyst component that is used in conjunction with a metallocene compound. In WO 96/23005 neutral triarylborane is reacted with a carrier having oxygen containing functionalities.

Magnesium chloride is a well-known support for titanium based catalyst systems. The use of this compound as a carrier for single-site catalysts could be very advantageous, in view of its chemical and structural simplicity, and to the possibility to finely control the porosity of this support and, therefore, to easily tune the porosity of the final catalyst system. However, when magnesium chloride has been suggested as a support for metallocene-based or other single-site transition metal catalyst systems, the catalyst components have simply been adsorbed on its surface.

For instance, in the examples of U.S. Pat. No. 5,444,134, [HNMe₂Ph]⁺[(C₆FS)₄B]⁻ is adsorbed on the surface of magnesium dichloride and the obtained material is reacted with a metallocene compound. It would be therefore desirable to provide a catalyst system comprising a compound of an element of group 13 of the Periodic Table such as boron tethered on the surface of a carrier, so as to avoid the drawbacks connected with the adsorption.

According to a first aspect, the present invention provides a catalyst component obtainable by contacting:
(a) a solid Lewis acid of formula MR¹ₐ wherein M is a metal of group 1-12 of the Periodic Table of the Elements; R¹ is a fluorine, chlorine, bromine or iodine atom; and a is equal to the valence of the metal M; with
(b) at least one ionic compound of formula (I):

[((T)ₚR²)ₙM^{I}(R³)ₘ]⁻[D]⁺ (I)
wherein
M^{I} is an element belonging to group 13 of the Periodic Table of the Elements;
R³, equal to or different from each other, are halogen atoms, halogenated C₆-C₂₀ aryl and halogenated C₇-C₂₀ alkylaryl groups; two R³ groups can also form with Ml a condensed ring, such as for example 9-borafluorene compounds;
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing one or more heteroatoms belonging to groups 13-17 of the Periodic Table of the Elements;
the radical R² is substituted with p T groups, wherein T is a Lewis base in its neutral form;
n ranges from 1 to 4; m ranges from 0 to 3; and m+n=4; p ranges from 1 to 10; and
[D]⁺ is a monovalent cation;

In the solid Lewis acid of formula MR¹ₐ preferably M belongs to groups 2-4 of the Periodic Table of the Elements and more preferably M belongs to group 2 of the Periodic Table of the Elements preferably M is magnesium. In addition, R¹ is preferably a chlorine atom. In the ionic compound of formula (I) preferably M¹ is a boron or aluminium atom; more preferably it is a boron atom. Preferably the substituents R³ are C₆F₅, C₆F₄H, C₆F₃H₂, C₆H₃(CF₃)₂, perfluoro-biphenyl, heptafluoro-naphthyl, hexafluoro-naphthyl and pentafluoro-naphthyl. The particularly preferred R³ substituents are C₆F₅ radicals. Preferably R² is a branched C₁-C₂₀ alkyl, or a or C₇-C₂₀ arylalkyl radical, optionally substituted with halogen atoms, preferably with fluorine atoms. Moreover, n is preferably 1, m is preferably 3 and p preferably ranges from 1 to 5 and more preferably is 1, 2 or 3. The monovalent cation [D]⁺ is preferably selected from phosphonium, anilinium, ammonium, or carbenium cation. Particularly preferred [D]⁺ is [C(C₆H₅)₃]⁺.

Particularly suitable solid Lewis acids of formula MR¹ₐ are the metal halide compounds that are in the solid form under standard conditions (atmospheric pressure and room temperature) such as MgCl₂, MgBr₂, MgF₂, MnCl₂ScCl₃, CaCl₃, ZrCl₄, and ZnCl₂. The preferred Lewis acid is magnesium halide, and more preferably it is MgCl₂. In particular, it is preferred to use magnesium halide with a surface area higher than 3 m²/g, preferably higher than 10 m²/g, more preferably higher than 15 m²/g. Moreover, the use of magnesium halide, especially MgCl₂, in active form is particularly suitable. Magnesium halides, especially MgCl₂, in such form are widely known from the patent literature as a support for Ziegler-Natta catalysts. U.S. Pat. No. 4,298,718 and U.S. Pat. No. 4,495,338 were the first to describe the use of these compounds in Ziegler-Natta catalysis. It is known from these patents that the magnesium dihalides in active form used as support in components of catalysts for the polymerization of olefins are characterized by X-ray spectra in which the most intense diffraction line that appears in the spectrum of the non-active halide is diminished in intensity and is broadened to form a halo.

Component (b) of the catalyst component object of the present invention is tethered to the surface of the solid Lewis acid through the one or more Lewis base moieties. In this way the cocatalyst is firmly bound and, as a consequence, the single-site transition metal catalyst component which is reacted with the cocatalyst becomes firmly bound on its turn on the surface of the carrier.

T is a Lewis base in its neutral form, so that the lone pair of the Lewis base can react with the solid Lewis acid of formula MR¹ₐ.

The T group is preferably selected from the group consisting of amino group, ether group, siloxy group, or ester group; among them the amino and ether groups are preferred.

Preferably T is NR⁴₂; PR⁴₂; OR⁴; SR⁴, Si(OR⁴)₃, SiR⁴(OR⁴)₂ and C(O)OR⁴ wherein R⁴ is a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radical, optionally containing one or more heteroatoms belonging to groups 13-17 of the Periodic Table of the Elements. Preferably R⁴ is a linear or branched, saturated or unsaturated C₁-C₂₀-alkyl radical; more preferably R⁴ is a methyl, or an ethyl radical.

A further object of the present invention is an adduct of formula (II):

(MR¹ₐ)_{q}¹.{[((T)ₚR²)ₙM^{I}(R³)ₘ]⁻[D]⁺}_{q}² (II)

wherein M, R¹, a, T, R², M^{I}, R³, D, p, n, and m have been described above and the ratio q¹/q² is comprised between 5 and 500; preferably between 30 and 200; more preferably between 50 and 100.

Examples of group R²(T)ₚ are:

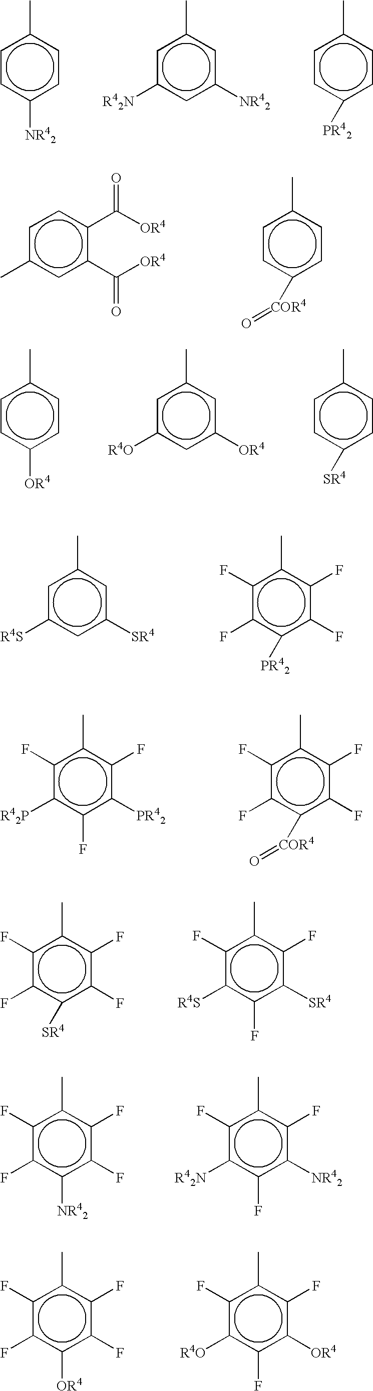

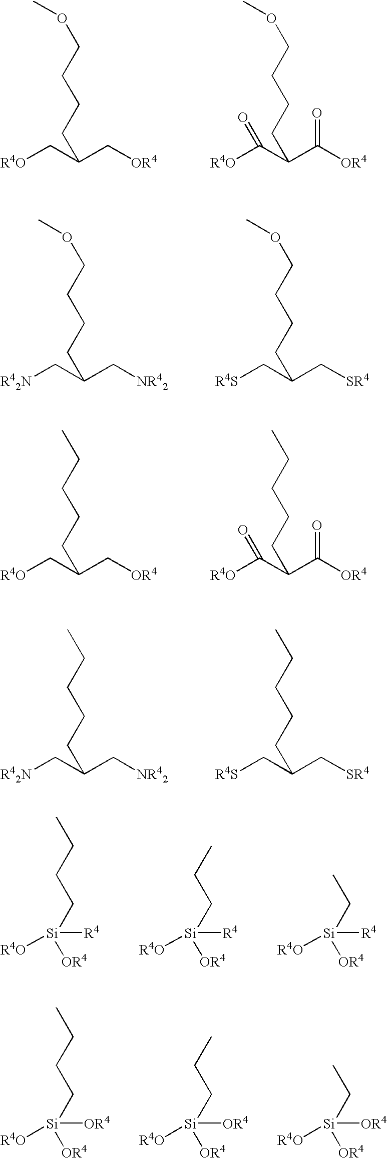

wherein R⁴ has been defined above

Examples of compounds belonging to formula (I) are:

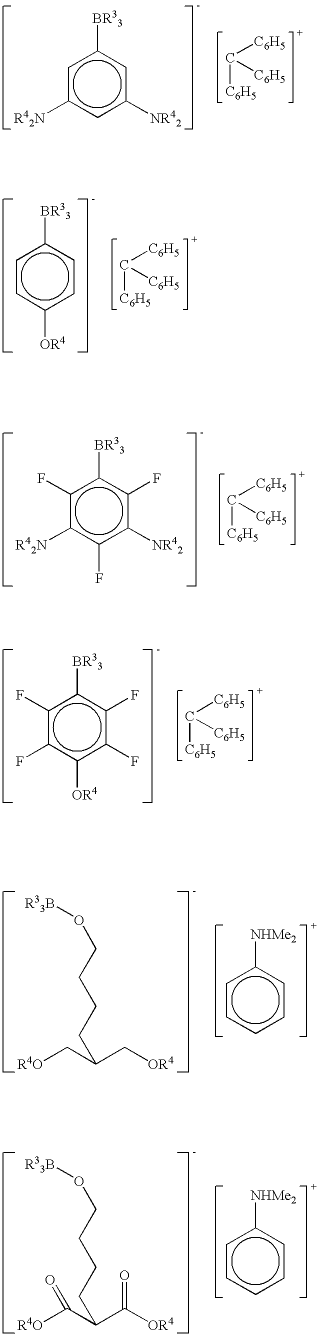

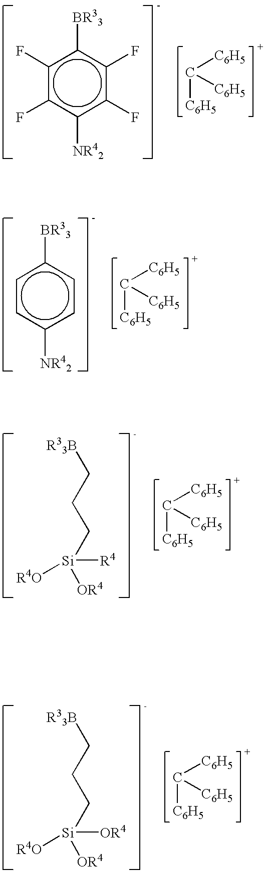

wherein R³ and R⁴ have been defined above.

Preferred compounds of formula (I) are those of formula (III)

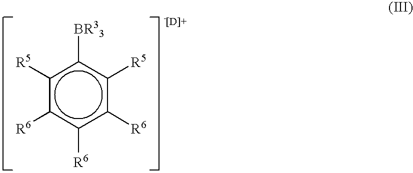

wherein

### [D]⁺ has been described above

### B is a boron atom;

### R³, equal to or different from each other, are halogen atoms, halogenated C₆-C₂₀ aryl and halogenated C₇-C₂₀ alkylaryl groups; two R³ groups can also form with the boron atom a condensed ring, such as for example 9-borafluorene compounds;

R⁵, equal to or different from each other, are hydrogen atoms, halogen atoms, or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; preferably R⁵, equal to or different from each other, are hydrogen atoms, halogen atoms, or linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements;

### R⁶, equal to or different from each other, have the same meaning of R⁵, or R⁶ is a T group, wherein T has been described above, provided that at least one R⁶ is a T group.

Preferably the substituents R³ are C₆F₅, C₆F₄H, C₆F₃H₂, C₆H₃(CF₃)₂, perfluoro-biphenyl, heptafluoro-naphthyl, hexafluoro-naphthyl and pentafluoro-naphthyl; most preferred R³ substituents are C₆F₅ radicals. Preferably R⁵ are hydrogen atoms or fluorine atoms

A further object of the present invention is a catalyst system obtainable by contacting:

(a) a solid Lewis acid of formula MR¹ₐ;
(b) at least a ionic compound of formula (I)

[((T)ₚR²)ₙM^{I}(R³)ₘ]⁻[D]⁺ (I)

(c) at least a transition metal organometallic compound; and optionally
(d) an organo aluminum compound.

Components a) and b) have been described above.

Transition metal organometallic compounds for use in the catalyst system in accordance with the present invention are compounds suitable as olefin polymerization catalysts by coordination or insertion polymerization. The class includes known transition metal compounds useful in traditional Ziegler-Natta coordination polymerization, the metallocene compounds similarly and the late transition metal compounds known to be useful in coordination polymerization. These will typically include Group 4-10 transition metal compounds wherein at least a metal ligand can be abstracted by the catalyst activators. As a rule, when said ligand is hydrogen or a hydrocarbyl group containing from 1 to 20 carbon atoms optionally containing silicon atoms, the transition metal organometallic catalyst compounds can be used as such, otherwise an alkylating agent has to be used in order to alkylate said catalyst. The alkylation can be carried out in a separate step or in situ.

The alkylating agent is a compound able to react with the transition metal organometallic compounds and exchange said ligand that can be abstracted, with an alkyl group. Example of said alkylating agent are compound of formulas R⁷Li, R⁷Na, R⁷K, R⁷MgU or AlR⁷_{3-z}W_{z} or alumoxanes, wherein R⁷ can be C₁-C₁₀ alkyl, alkenyl or alkylaryl radicals, optionally containing one or more Si or Ge atoms, z is 0, 1 or 2 or a non integer number ranging from 0 to 2; U is chlorine, bromine or iodine and W is hydrogen or chlorine, bromine or iodine atom; non-limiting examples of R⁷ are methyl, ethyl, butyl and benzyl; non limiting example of AlR⁷_{3-z}W_{z} compounds are trimethylaluminum (TMA), tris(2,4,4-trimethylpentyl)aluminum (TIOA), tris(2-methyl-propyl)aluminum (TIBA), tris(2,3,3-trimethylbutyl)aluminum, tris(2,3-dimethyl-hexyl)aluminum, tris(2,3-dimethyl-butyl)aluminum, tris(2,3-dimethyl-pentyl)aluminum, tris(2,3-dimethyl-heptyl)aluminum, tris(2-methyl-3-ethyl-pentyl)aluminum and tris(2-ethyl-3,3-dimethyl-butyl). Non limiting example of alumoxanes are: methylalumoxane (MAO), tetra-(isobutyl)alumoxane (TEBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

A preferred class of transition metal organometallic compounds are metallocene compounds. Metallocene compounds are compounds wherein at least a cyclopentadienyl moiety is bound to a transition metal through a 7r bond. Preferably the transition metal belongs to group 4 of the Periodic Table of the Elements.

A preferred class of metallocene compounds belongs to the following formula (IV)

(Cp)(ZR⁸ₓ)_{y}(A)ᵣM^{II}L_{w} (I)

wherein (ZR⁸ₓ)_{y} is a divalent group bridging Cp and A; Z being C, Si, Ge, N or P, and the R⁸ groups, equal to or different from each other, being hydrogen or linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl groups or two R⁸ can form a aliphatic or aromatic C₄-C₇ ring;

### Cp is a substituted or unsubstituted cyclopentadienyl group, optionally condensed to one or more substituted or unsubstituted, saturated, unsaturated or aromatic rings, containing from 4 to 6 carbon atoms, optionally containing one or more heteroatoms;

### A is O, S, NR⁹, PR⁹ wherein R⁹ is hydrogen, a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl, or A has the same meaning of Cp;

M^{II} is a transition metal belonging to group 4, 5 or to the lanthanide or actinide groups of the Periodic Table of the Elements IUPAC version); the substituents L, equal to or different from each other, are monoanionic sigma ligands selected from the group consisting of hydrogen, halogen, R¹⁰, OR¹⁰, OCOR¹⁰, SR¹⁰, NR¹⁰₂ and PR¹⁰₂, wherein R¹⁰ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms; preferably, the substituents L are the same;
x is 1 or 2, and more specifically it is 1 when Z is N or P, and it is 2 when Z is C, Si or Ge;
y is an integer ranging from 0 to 4;
r is 0, 1 or 2; preferably 0 or 1; y is 0 when r is 0;
w is an integer equal to the oxidation state of the metal M minus r+1; i.e. minus 3 when r=2, minus 2 when r=1, and minus 1 when r=0, and ranges from 1 to 4.

In the metallocene compound of formula (IV), the divalent bridge (ZR⁸ₓ)_{y} is preferably selected from the group consisting of CR⁸₂, (CR⁸₂)₂, (CR⁸₂)₃, SiR⁸₂, GeR⁸₂, NR⁸ and PR⁸, R⁸ having the meaning reported above; more preferably, said divalent bridge is Si(CH₃)₂, SiPh₂, CH₂, (CH₂)₂, (CH₂)₃ or C(CH₃)₂.

The ligand Cp, which is r-bonded to said metal M^{II}, is preferably selected from the group consisting of cyclopentadienyl, mono-, di-, tri- and tetra-methyl cyclopentadienyl; 4-^{t}butyl-cyclopentadienyl; 4-adamantyl-cyclopentadienyl; indenyl; mono-, di-, tri- and tetra-methyl indenyl; 2-methyl indenyl, 3-^{t}butyl-indenyl, 2-methyl-4-phenyl indenyl, 2-methyl-4,5 benzo indenyl; 3-trimethylsilyl-indenyl; 4,5,6,7-tetrahydroindenyl; fluorenyl; 5,10-dihydroindeno[1,2-b]indol-10-yl; N-methyl- or N-phenyl-5,10-dihydroindeno[1,2-b]indol-10-yl; 5,6-dihydroindeno[2,1-b]indol-6-yl; N-methyl- or N-phenyl-5,6-dihydroindeno[2,1-b]indol-6-yl; azapentalene-4-yl; thiapentalene-4-yl; azapentalene-6-yl; thiapentalene-6-yl; mono-, di- and tri-methyl-azapentalene-4-yl, 2,5-dimethyl-cyclopenta[1,2-b:4,3-b′]-dithiophene.

The group A is preferably O, S, N(R⁹), wherein R⁹ is hydrogen, a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl, preferably R⁹ is methyl, ethyl, n-propyl, isopropyl, n-butyl, t-butyl, phenyl, p-n-butyl-phenyl, benzyl, cyclohexyl and cyclododecyl; more preferably R⁹ is t-butyl; or A has the same meaning of Cp.

Preferably the metal M^{II} is zirconium titanium or hafnium.

Non limiting examples of compounds belonging to formula (I) are the following compounds (when possible in either their meso or racemic isomers, or mixtures thereof):
bis(cyclopentadienyl)zirconium dimethyl;
bis(indenyl)zirconium dimethyl;
bis(tetrahydroindenyl)zirconium dimethyl;
bis(fluorenyl)zirconium dimethyl;
(cyclopentadienyl)(indenyl)zirconium dimethyl;
(cyclopentadienyl)(fluorenyl)zirconium dimethyl;
(cyclopentadienyl)(tetrahydroindenyl)zirconium dimethyl;
(fluorenyl)(indenyl)zirconium dimethyl;
dimethylsilanediylbis(indenyl)zirconium dimethyl,
dimethylsilanediylbis(2-methyl-4-phenylindenyl)zirconium dimethyl,
dimethylsilanediylbis(4-naphthylindenyl)zirconium dimethyl,
dimethylsilanediylbis(2-methylindenyl)zirconium dimethyl,
dimethylsilanediylbis(2-methyl-4-t-butylindenyl)zirconium dimethyl,
dimethylsilanediylbis(2-methyl-4-isopropylindenyl)zirconium dimethyl,
dimethylsilanediylbis(2,4-dimethylindenyl)zirconium dimethyl,
dimethylsilanediylbis(2-methyl-4,5-benzoindenyl)zirconium dimethyl,
dimethylsilanediylbis(2,4,7-trimethylindenyl)zirconium dimethyl,
dimethylsilanediylbis(2,4,6-trimethylindenyl)zirconium dimethyl,
dimethylsilanediylbis(2,5,6-trimethylindenyl)zirconium dimethyl,
methyl(phenyl)silanediylbis(2-methyl-4,6-diisopropylindenyl)-zirconium dimethyl,
methyl(phenyl)silanediylbis(2-methyl-4-isopropylindenyl)-zirconium dimethyl,
1,2-ethylenebis(indenyl)zirconium dimethyl,
1,2-ethylenebis(4,7-dimethylindenyl)zirconium dimethyl,
1,2-ethylenebis(2-methyl-4-phenylindenyl)zirconium dimethyl,
1,4-butanediylbis(2-methyl-4-phenylindenyl)zirconium dimethyl,
1,2-ethylenebis(2-methyl-4,6-diisopropylindenyl)zirconium dimethyl,
1,4-butanediylbis(2-methyl-4-isopropylindenyl)zirconium dimethyl,
1,4-butanediylbis(2-methyl-4,5-benzoindenyl)zirconium dimethyl,
1,2-ethylenebis(2-methyl-4,5-benzoindenyl)zirconium dimethyl,
[4-(η⁵-cyclopentadienyl)-4,6,6-trimethyl(η⁵-4,5-tetrahydro-pentalene)]dimethylzirconium,
[4-(η⁵-3′-trimethylsilylcyclopentadienyl)-4,6,6-trimethyl(η⁵-4,5-tetrahydropentalene)]dimethylzirconium,
(tert-butylamido)(tetramethyl-η⁵-cyclopentadienyl)-1,2-ethane-dimethyltitanium,
(methylamido)(tetramethyl-η⁵-cyclopentadienyl)dimethylsilyl-dimethyltitanium,
(methylamido)(tetramethyl-η⁵-cyclopentadienyl)-1,2-ethanediyl-dimethyltitanium,
(tertbutylamido)-(2,4-dimethyl-2,4-pentadien-1-yl)dimethylsilyl-dimethyltitanium,
bis(1,3-diimethylcyclopentadienyl)zirconium dimethyl,
methylene(3-methyl-cyclopentadienyl)-7-(2,5-dimethylcyclopentadienyl-[1,2-b:4,3-b′]dithiophene)zirconium dimethyl;
methylene(3-isopropyl-cyclopentadienyl)-7-(2,5-dimethylcyclopentadienyl-[1,2-b:4,3-b′]dithiophene)zirconium dimethyl;
methylene(2,4-dimethyl-cyclopentadienyl)-7-(2,5-dimethylcyclopentadienyl-[1,2-b:4,3-b′]dithiophene)zirconium dimethyl;
methylene(2,3,5-trimethyl-cyclopentadienyl)-7-(2,5-dimethylcyclopentadienyl-[1,2-b:4,3-b′]dithiophene)zirconium dimethyl;
methylene-1-(indenyl)-7-(2,5-dimethylcyclopentadienyl-[1,2-b:4,3-b′]dithiophene)zirconium dimethyl and dimethyl;
methylene-1-(indenyl)-7-(2,5-ditrimethylsilylcyclopentadienyl-[1,2-b:4,3-b′]dithiophene)zirconium dimethyl;
methylene-1-(3-isopropyl-indenyl)-7-(2,5-dimethylcyclopentadienyl-[1,2-b:4,3-b′]dithiophene)zirconium dimethyl;
methylene-1-(2-methyl-indenyl)-7-(2,5-dimethylcyclopentadienyl-[1,2-b:4,3-b′]dithiophene)zirconium dimethyl;
methylene-1-(tetrahydroindenyl)-7-(2,5-dimethylcyclopentadienyl-[1,2-b:4,3-b′]dithiophene)zirconium dimethyl;
methylene(2,4-dimethyl-cyclopentadienyl)-7-(2,5-dimethylcyclopentadienyl-[1,2-b:4,3-b′]dioxazol)zirconium dimethyl;
methylene(2,3,5-t ethyl-cyclopentadienyl)-7-(2,5-dimethylcyclopentadienyl-[1,2-b:4,3-b′]dioxazol)zirconium dimethyl;
methylene-1-(indenyl)-7-(2,5-dimethylcyclopentadienyl-[1,2-b:4,3-b′]dioxazol)zirconium dimethyl and dimethyl;
isopropylidene(3-methyl-cyclopentadienyl)-7-(2,5-dimethylcyclopentadienyl-[1,2-b:4,3-b′]dithiophene)zirconium dimethyl;
isopropylidene(2,4-dimethyl-cyclopentadienyl)-7-(2,5-dimethylcyclopentadienyl-[1,2-b:4,3-b′]dithiophene)zirconium dimethyl;
isopropylidene(2,4-diethyl-cyclopentadienyl)-7-(2,5-dimethylcyclopentadienyl-[1,2-b:4,3-b′]dithiophene)zirconium dimethyl;
isopropylidene(2,3,5-trimethyl-cyclopentadienyl)-7-(2,5-dimethylcyclopentadienyl-[1,2-b:4,3-b′]dithiophene)zirconium dimethyl;
isopropylidene-1-(indenyl)-7-(2,5-dimethylcyclopentadienyl-[1,2-b:4,3-b′]dithiophene)zirconium dimethyl;
isopropylidene-1-(2-methyl-indenyl)-7-(2,5-dimethylcyclopentadienyl-[1,2-b:4,3-b′]dithiophene)zirconium dimethyl;
dimethylsilanediyl-1-(2-methyl-indenyl)-7-(2,5-dimethylcyclopentadienyl-[1,2-b:4,3-b′]dithiophene)hafnium dimethyl;
dimethylsilanediyl(3-tert-butyl-cyclopentadienyl)(9-fluorenyl)zirconium dimethyl,
dimethylsilanediyl(3-isopropyl-cyclopentadienyl)(9-fluorenyl)zirconium dimethyl,
dimethylsilanediyl(3-methyl-cyclopentadienyl)(9-fluorenyl)zirconium dimethyl,
dimethylsilanediyl(3-ethyl-cyclopentadienyl)(9-fluorenyl)zirconium dimethyl,
1-2-ethane(3-tert-butyl-cyclopentadienyl)(9-fluorenyl)zirconium dimethyl,
1-2-ethane (3-isopropyl-cyclopentadienyl)(9-fluorenyl)zirconium dimethyl,
1-2-ethane (3-methyl-cyclopentadienyl)(9-fluorenyl)zirconium dimethyl,
1-2-ethane (3-ethyl-cyclopentadienyl)(9-fluorenyl)zirconium dimethyl,
dimethylsilanediylbis-6-(3-methylcyclopentadienyl-[1,2-b]-thiophene)dimethyl;
dimethylsilanediylbis-6-(4-methylcyclopentadienyl-[1,2-b]-thiophene)zirconium dimethyl;
dimethylsilanediylbis-6-(4-isopropylcyclopentadienyl-[1,2-b]-thiophene)zirconium dimethyl;
dimethylsilanediylbis-6-(4-tert-butylcyclopentadienyl-[1,2-b]-thiophene)zirconium dimethyl;
dimethylsilanediylbis-6-(3-isopropylcyclopentadienyl-[1,2-b]-thiophene)zirconium dimethyl;
dimethylsilanediylbis-6-(3-phenylcyclopentadienyl-[1,2-b]-thiophene)zirconium dimethyl;
dimethylsilanediylbis-6-(2,5-diethyl-3-phenylcyclopentadienyl-[1,2-b]-thiophene)zirconium dimethyl;
dimethylsilanediylbis-6-[2,5-dimethyl-3-(2-methylphenyl)cyclopentadienyl-[1,2-b]-thiophene]zirconium dimethyl;
dimethylsilanediylbis-6-[2,5-dimethyl-3-(2,4,6-trimethylphenyl)cyclopentadienyl-[1,2-b]-thiophene]zirconium dimethyl;
dimethylsilanediylbis-6-[2,5-dimethyl-3-mesitylenecyclopentadienyl-[1,2-b]-thiophene]zirconium dimethyl;
dimethylsilanediylbis-6-(2,4,5-trimethyl-3-phenylcyclopentadienyl-[1,2-b]-thiophene)zirconium dimethyl;
dimethylsilanediylbis-6-(2,5-diethyl-3-phenylcyclopentadienyl-[1,2-b]-thiophene)zirconium dimethyl;
dimethylsilanediylbis-6-(2,5-diisopropyl-3-phenylcyclopentadienyl-[1,2-b]-thiophene)zirconium dimethyl;
dimethylsilanediylbis 6-(2,5-diter-butyl-3-phenylcyclopentadienyl-[1,2-b]-thiophene)zirconium dimethyl;
dimethylsilanediylbis-6-(2,5-ditrimethylsilyl-3-phenylcyclopentadienyl-[1,2-b]-thiophene)zirconium dimethyl;
dimethylsilanediylbis-6-(3-methylcyclopentadienyl-[1,2-b]-silole)zirconium dimethyl;
dimethylsilanediylbis-6-(3-isopropylcyclopentadienyl-[1,2-b]-silole)zirconium dimethyl;
dimethylsilanediylbis-6-(3-phenylcyclopentadienyl-[1,2-b]-silole)zirconium dimethyl;
dimethylsilanediylbis-6-(2,5-dimethyl-3-phenylcyclopentadienyl-[1,2-b]-silole)zirconium dimethyl;
dimethylsilanediylbis-6-[2,5-dimethyl-3-(2-methylphenyl)cyclopentadienyl-[1,2-b]-silole]zirconium dimethyl;
dimethylsilanediylbis-6-[2,5-dimethyl-3-(2,4,6-trimethylphenyl)cyclopentadienyl-[1,2-b]-silole]zirconium dimethyl;
dimethylsilanediylbis-6-[2,5-dimethyl-3-mesitylenecyclopentadienyl-[1,2-b]-silole]zirconium dimethyl;
dimethylsilanediylbis-6-(2,4,5-trimethyl-3-phenylcyclopentadienyl-[1,2-b]-silole)zirconium dimethyl; [dimethylsilyl(tert-butylamido)][(N-methyl-1,2-dihydrocyclopenta[2,1-b]indol-2-yl)]titanium dimethyl;
[dimethylsilyl(tert-butylamido)][(6-methyl-N-methyl-1,2-dihydrocyclopenta[2,1-b]indol-2-yl)]titanium dimethyl;
[dimethylsilyl(tert-butylamido)][(6-methoxy-N-methyl-1,2-dihydrocyclopenta[2,1-b]indol-2-yl)]titanium dimethyl;
[dimethylsilyl(tert-butylamido)][(N-ethyl-1,2-dihydrocyclopenta[2,1-b]indol-2-yl)]titanium dimethyl;
[dimethylsilyl(tert-butylamido)][(N-phenyl-1,2-dihydrocyclopenta[2,1-b]indol-2-yl)]titanium dimethyl;
[dimethylsilyl(tert-butylamido)][(6-methyl-N-phenyl-1,2-dihydrocyclopenta[2,1-b]indol-2-yl)]titanium dimethyl;
[dimethylsilyl(tert-butylamido)][(6-methoxy-N-phenyl-1,2-dihydrocyclopenta[2,1-b]indol-2-yl)]titanium dimethyl;
[dimethylsilyl(tert-butylamido)][N-methyl-3,4-dimethyl-1,2-dihydrocyclopenta[2,1-b]indol-2-yl)]titanium dimethyl;
[dimethylsilyl(tert-butylamido)][(N-ethyl-3,4-dimethyl-1,2-dihydrocyclopenta[2,1-b]indol-2-yl)]titanium dimethyl;
[dimethylsilyl(tert-butylamido)][(N-phenyl-3,4-dimethyl-1,2-dihydrocyclopenta[2,1-b]indol-2-yl)]titanium dimethyl;
   as well as the corresponding dichloro, hydrochloro and dihydro compounds and the corresponding η⁴-butadiene compounds.

When A is N(R⁹), a suitable class of metallocene complexes (c) for use in the catalysts complexes of the invention comprises the well-known constrained geometry catalysts, as described in EP-A-0 416 815, EP-A-0 420 436, EP-A-0 671 404, EP-A-0 643 066 and WO-A-91/04257.

According to a preferred embodiment of the invention, the group A has the same meaning of Cp, and it is preferably substituted or unsubstituted cyclopentadienyl, indenyl, tetrahydroindenyl, 2,5-dimethyl-cyclopenta[1,2-b:4,3-b′]-dithiophene.

Suitable metallocene complexes that may be used in the catalyst system according to the present invention are described in WO 98/22486, WO 99/58539 WO 99/24446, U.S. Pat. No. 5,556,928, WO 96/22995, EP-485822, EP-485820, U.S. Pat. No. 5,324,800 and EP-A-0 129 368.

The substituents L are preferably the same and are selected from the group consisting of halogens, R¹⁰, OR¹⁰ and NR¹⁰₂; wherein R¹⁰ is a C₁-C₇ alkyl, C₆-C₁₄ aryl or C₇-C₁₄ arylalkyl group, optionally containing one or more Si or Ge atoms; more preferably, the substituents L are selected from the group consisting of —Cl, —Br, -Me, -Et, -n-Bu, -sec-Bu, -Ph, -Bz, —CH₂SiMe₃, —OEt, —OPr, —OBu, —OBz and —NMe₂, even more preferably L is methyl.

The integer n ranges from 0 to 4, and it is preferably 1 or 2.

When n=0 and r=1, A can have only the meaning of Cp; Cp and A are preferably pentamethyl cyclopentadienyl, or indenyl.

When n=1 or 2 and r=1, Cp and A, same or different from each other, are preferably cyclopentadienyl, tetramethyl-cyclopentadienyl, indenyl, 4,5,6,7-tetra-hydro-indenyl, 2-methyl-4,5,6,7-tetra-hydro-indenyl, 4,7-dimethyl-4,5,6,7-tetra-hydroindenyl, 2,4,7-trimethyl-4,5,6,7-tetra-hydro-indenyl or fluorenyl groups; (ZR⁸ₘ)O is preferably Me₂Si, Me₂C, CH₂ or C₂H₄.

Suitable metallocene complexes (c) are the bridged bis-indenyl metallocenes as described for instance in U.S. Pat. No. 5,145,819 and EP-A-0 485 823.

Further metallocene complexes suitable for the catalyst system of the invention are the classes of heterocyclic metallocenes described in WO 98/22486 and WO 99/24446. Among these metallocenes, particularly preferred are the ones reported from page 15, line 8 to page 24, line 17; from page 25, line 1 to page 31, line 9; and from page 58, penultimate line, to page 63, line 20 of WO 98/22486. Other preferred metallocenes are the ones obtained from the bridged ligands listed from page 11, line 18, to page 14, line 13 of WO 99/24446

When A is N(R⁸), a suitable class of metallocene complexes (A) for use in the catalysts complexes of the invention comprises the well-known constrained geometry catalysts, as described in EP-A-0 416 815, EP-A-0 420 436, EP-A-0 671 404, EP-A-0 643 066 and WO-A-91/04257.

According to a preferred embodiment of the invention, the group A has the same meaning of Cp, and is preferably substituted or unsubstituted cyclopentadienyl, indenyl, tetrahydroindenyl (2,5-dimethyl-cyclopenta[1,2-b:4,3-b′]-dithiophene).

Suitable metallocene complexes that may be used in the catalyst system according to the present invention are described in WO 98/22486, WO 99/58539 WO 99/24446, U.S. Pat. No. 5,556,928, WO 96/22995, EP-485822, EP-485820, U.S. Pat. No. 5,324,800 and EP-A-0 129 368.

The metal M is preferably Ti, Zr or Hf, and more preferably Zr.

The substituents L are preferably the same and are selected from the group consisting of halogens, R⁹, OR⁹ and NR⁹²; wherein R⁹ is a C₁-C₇ alkyl, C₆-C₁₄ aryl or C₇-C₁₄ arylalkyl group, optionally containing one or more Si or Ge atoms; more preferably, the substituents L are selected from the group consisting of —Cl, —Br, -Me, -Et, -n-Bu, -sec-Bu, -Ph, -Bz, —CH₂SiMe₃, —OEt, —OPr, —OBu, —OBz and —NMe₂, even more preferably L is methyl.

The integer n ranges from 0 to 4, and it is preferably 1 or 2.

When n=0 and r=1, A can have only the meaning of Cp; Cp and A are preferably pentamethyl cyclopentadienyl, indenyl or 4,5,6,7-tetrahydroindenyl groups.

When n=1 or 2 and r=1, Cp and A, same or different from each other, are preferably cyclopentadienyl, tetramethyl-cyclopentadienyl, indenyl, 4,5,6,7-tetra-hydro-indenyl, 2-methyl-4,5,6,7-tetra-hydro-indenyl, 4,7-dimethyl-4,5,6,7-tetra-hydroindenyl, 2,4,7-trimethyl-4,5,6,7-tetra-hydro-indenyl or fluorenyl groups; (ZR⁷ₘ)ₙ is preferably Me₂Si, Me₂C, CH₂ or C₂H₄.

Suitable metallocene complexes (A) are the bridged bis-indenyl metallocenes as described for instance in U.S. Pat. No. 5,145,819 and EP-A-0 485 823.

Further metallocene complexes suitable for the catalyst system of the invention are the classes of heterocyclic metallocenes described in WO 98/22486 and WO 99/24446. Among these metallocenes, particularly preferred are the ones reported from page 15, line 8 to page 24, line 17; from page 25, line 1 to page 31, line 9; and from page 58, penultimate line, to page 63, line 20 of WO 98/22486. Other preferred metallocenes are the ones obtained from the bridged ligands listed from page 11, line 18, to page 14, line 13 of WO 99/24446

A further preferred class of transition metal organometallic compounds are late transition metal complex of formula (V) or (VI)

L^{a}M^{III}X^{a}ₚ^{a} (V)

L^{a}M^{III}A^{a} (VI)

wherein M^{III} is a metal belonging to Group 8, 9, 10 or 11 of the Periodic Table of the Elements (new IUPAC notation);

L^{a} is a bidentate or tridentate ligand of formula (VII):

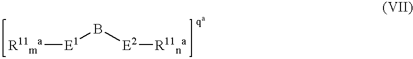

wherein:

### B is a C₁-C₅₀ bridging group linking E¹ and E², optionally containing one or more atoms belonging to Groups 13-17 of the Periodic Table of the Elements;

E¹ and E², the same or different from each other, are elements belonging to Group 15 or 16 of the Periodic Table of the Elements and are bonded to said metal Mm; the substituents R¹¹, equal to or different from each other, are selected from the group consisting of hydrogen, linear or branched, saturated or unsaturated C₁-C₂₀ alkyl, C₃-C₂₀ cycloalkyl, C₆-C₂₀ aryl, C₇-C₂₀ alkylaryl and C₇-C₂₀ arylalkyl radicals, optionally containing one or more atoms belonging to groups 13-17 of the Periodic Table of the Elements of the Elements (such as B, Al, Si, Ge, N, P, O, S, F and Cl atoms); or two R¹¹ substituents attached to the same atom E¹ or E² form a saturated, unsaturated or aromatic C₄-C₇ ring, having from 4 to 20 carbon atoms;
m^{a} and n^{a} are independently 0, 1 or 2, depending on the valence of E¹ and E², so to satisfy the valence number of E¹ and E²; q^{a} is the charge of the bidentate or tridentate ligand so that the oxidation state of M^{III}X^{a}ₚX^{a}′ₛ or M^{III}A^{a} is satisfied, and the compound (V) or (VI) is overall neutral;
X^{a}, the same or different from each other, are monoanionic sigma ligands selected from the group consisting of hydrogen, halogen, R¹², OR¹², OSO₂CF₃, OCOR¹², SR¹², —NR¹²₂ and PR¹²₂ groups, wherein the R¹² substituents are linear or branched, saturated or unsaturated, C₁-C₂₀ alkyl, C₃-C₂₀ cycloalkyl, C₆-C₂₀ aryl, C₇-C₂₀ alkylaryl or C₇-C₂₀ arylalkyl radicals, optionally containing one or more atoms belonging to groups 13-17 of the Periodic Table of the Elements of the Elements (new IUPAC notation), such as B, N, P, Al, Si, Ge, O, S and F atoms; or two X^{a} groups form a metallacycle ring containing from 3 to 20 carbon atoms; the substituents X^{a} are preferably the same;
p^{a} is an integer ranging from 0 to 3, so that the final compound (V) or (VI) is overall neutral; and

### A^{a} is a π-allyl or a π-benzyl group.

Non limiting examples of late transition metal complexes are those described in WO 96/23010, WO 97/02298, WO 98/40374; and J. Am. Chem. Soc. 1998, 120, 4049-4050; Brookhart et al, J. Am. Chem. Soc. 1995, 117, 6414; Brookhart et al, J. Am. Chem. Soc., 1996, 118, 267; Brookhart et al, J. Am. Chem. Soc. 1998, 120, 4049; Gibson et al, Chem. Commun. 1998, 849, WO 96/27439 and Chem. Ber./Recl. (1997), 130(3), 399-403.

Organo-aluminium compounds used as component d) have formula AlR⁷_{3-z}W_{z} described above.

The amount of the heterogeneous catalyst obtainable by contacting compound a) and compound b) to be used form obtaining the catalyst system described above preferably is so that the molar ratio between the a ionic compound of formula (I) and the transition metal organometallic compound (c), calculated as the molar ratio between the metal Ml of the ionic compound of formula (I) and the metal of the transition metal organometallic compound, preferably ranges from 10:1 to 1:10, more preferably from 2:1 to 1:2, and even more preferably is about 1:1.

The catalyst system of the present invention can be used for homo and copolymerizing olefins, preferably alpha olefins.

Thus according to a still further aspect of the present invention a process is provided for the preparation of polymers of alpha-olefins comprising contacting one or more alpha-olefins under polymerization conditions in the presence of a catalyst system described above. The process for the polymerization of olefins according to the invention can be carried out in the liquid phase in the presence or absence of an inert hydrocarbon solvent, or in the gas phase. The hydrocarbon solvent can either be aromatic such as toluene, or aliphatic such as propane, hexane, heptane, isobutane or cyclohexane.

The polymerization temperature is generally comprised between −100° C. and +100° C. and, particularly between 10° C. and +90° C. The polymerization pressure is generally comprised between 0.5 and 100 bar.

Examples of alpha-olefins to be used in the polymerization process of the present invention are ethylene, propylene, 1-butene, 1-pentene, 1-hexene, 4-methyl-1-pentene, 1-octene, 1-decene, 1-dodecene, styrene, 1,5-hexadiene and 1,7-octadiene.

Preferred alpha olefins are ethylene, propylene and 1-butene that can be homo or copolymerized with one or more alpha olefins and optionally with one or more polyenes.

The polyenes that can be used as comonomers in the copolymers according to the present invention are included in the following classes:
non-conjugated diolefins able to cyclopolymerize such as, for example, 1,5-hexadiene, 1-6-heptadiene, 2-methyl-1,5-hexadiene;
dienes capable of giving unsaturated monomeric units, in particular conjugated dienes such as, for example, butadiene and isoprene, and linear non-conjugated dienes, such as, for example, trans 1,4-hexadiene, c is 1,4-hexadiene, 6-methyl-1,5-heptadiene, 3,7-dimethyl-1,6-octadiene, 11-methyl-1,10-dodecadiene, and cyclic non-conjugated dienes such as 5-ethylidene-2-norbornene.

A further object of the present invention is a compound of formula (I)

[((T)ₚR²)ₙM^{I}(R³)ₘ]⁻[D]⁺ (I)

wherein T, R², M^{I}, R³, D, p, n, and m have been described above.

Preferably the compound of formula (I) has formula (III) described above.

The following examples are given in order to illustrate and not limit the invention.

### EXAMPLES

### Example 1

### Synthesis of Trityl[dimethylaminophenyl-4-tris(perfluorophenyl)borate](TrT)

### a) Synthesis of 4-Lithium-N,N-dimethylaniline (1)

A solution of 4-Bromo-N,N-dimethylaniline (9.8 mmol) in diethylether (40 mL) is cooled at −80° C. in a liquid-N₂/acetone bath, and slowly added with a 1.6 mol/L solution of butyllithium in hexane (6.1 mL/9.8 mmol, diluted with 6 mL of diethylether). After the addition, the mixture is allowed to react by rising the temperature up to 0° C. in 4 hours. The solvent is then evaporated under vacuum, and 4-Lithium-N,N-dimethylaniline (1), in the form of a white solid, is washed with pentane (3×25 mL) and recovered in nearly quantitative yield.

### b) Synthesis of Trityl[dimethylaminophenyl-4-tris(perfluorophenyl)borate](TrT)

A solution of B(C₆F₅)₃ (1.7 mmol) in toluene (20 mL) is added dropwise to a solution of (1) (1.7 mmol) in toluene (30 mL) at −80° C. After the addition, the temperature is allowed to rise slowly up to 0° C. over 4 hours. The solution becomes turbid and green-colored, due to the formation of Lithium [dimethylaminophenyl-4-tris(perfluorophenyl)borate]. The system is then cooled again to 40° C., and a solution of ClC(C₆H₅)₃ (1.7 mmol) in toluene (20 mL) is added dropwise. The mixture is stirred for 12 hours, during which it is allowed to warm up to room temperature. The solvent is removed under vacuum, leaving behind TrT, as a green solid, and LiCl. By addition of 10 mL of CH₂Cl₂, TrT is re-dissolved, and after cooling to −40° C. LiCl(s) is filtered off. The system is finally brought to dryness under vacuum, and pure TrT is obtained after washing twice with heptane (2×10 mL); yield, 75%.

### Example 2

### Preparation of a MgCl₂-TrT Adduct

Chemically activated, pure MgCl₂ (1.5 g/15.7 mmol), prepared as described in the literature (Auriemma, F.; Talarico, G.; Corradini, P., in: “Progress and Development of Catalytic Olefin Polymerization”; Sano, T. Uozomi, T. Nakatani, H., Terano, M. Eds.; Technology and Education Publishers: Tokyo 2000; pp. 7-15) is suspended in toluene (35 mL). TrT (0.79 mmol) is then added, and the suspension is kept at 60° C. for 4 hours under vigorous stirring. The solid is recovered by filtration, washed with toluene (3×15 mL) under stirring (10 min at 60° C. for each washing), and finally dried under vacuum.

The content of TrT in the adduct is determined as follows. A weighed aliquot, of MgCl₂-TrT (^{˜}10 mg) is dissolved in CD₃OD, 1.0 μL of CH₃CN is added as an internal standard, and an ¹H-NMR spectrum is recorded. By integration of the resonances due to the methyl protons of TrT (2.85 ppm downfield of TMS) and CH₃CN (2.0 ppm), the weight amount of TrT in MgCl₂-TrT is estimated to be 12% (Mg/TrT mole ratio ^{˜}65).

### Example 3

### Supportation of rac-dimethylsilyl-bis(1-Indenyl)ZrCl₂ on MgCl₂-TrT Adduct

Rac-dimethylsilyl-bis(1-Indenyl)ZrCl₂ (23 mg/5.1×10⁻² mmol) is dissolved in toluene (10 mL), and pre-treated with Al(i-Bu)₃ (Al/Zr mole ratio=4) at room temperature under stirring for 20 min. This solution, and 40 mL of toluene/Al(i-Bu)₃ (1000/1 v/v), are then added to a suspension of MgCl₂-TrT adduct (407 mg, corresponding to 5.6×10⁻² mmol of TrT) in toluene (10 mL). The resulting suspension is heated up to 60° C. and kept under stirring for 1 h, after which a pink solid is recovered by filtration, washed with toluene/Al(i-Bu)³ (1000/1 v/v-3×20 mL) under stirring (10 min at 60° C. for each washing), and finally dried under vacuum.

The contents of [Tr]⁻ (determined by NMR as previously described) and of [Rac-dimethylsilyl-bis(1-Indenyl)Zr(i-Bu)]⁺ (measured colorimetrically) in the solid turned out to be 5.5% and 1.8% by weight, respectively (which corresponds to a Zr/B mole ratio of 0.5).

### Example 4

### Ethylene Homopolymerization

A solution of Al(i-Bu)₃ (0.48 mL) in toluene (400 mL) is charged in a 2 L stainless steel reactor (Brignole, mod. AU-2) and saturated at 60° C. with ethylene at a partial pressure p(C₂H₄)=6.0 bar. The polymerization is started by breaking a glass vial containing 98 mg of the catalyst system prepared in example 3 (corresponding to 1.8 mg/4.1 μmol of [Rac-dimethylsilyl-bis(1-Indenyl)Zr(i-Bu)]⁺, Al/Zr mole ratio=5×10²), and allowed to proceed for 15 min, after which it is stopped by venting the reactor. The polymer is recovered in the form of a free-flowing powder, with no reactor fouling. Yield, 10.5 g (corresponding to a productivity of 2.5×10⁴ kg(PE)/[mol(Zr)xmol/L(ethylene)xh].

Results of polymer characterization:

### (DSC, on 2^{nd} heating scan) Tₘ=135° C.; Δhₘ=182 J/g.

### (GPC) Mₙ=7.0×10⁴ Da, M_{w}=1.6×10⁵ Da, M_{w}/Mₙ=2.3

### Example 5

### Propylene Homopolymerization

A solution of Al(i-Bu)₃ (0.80 mL) in toluene (400 mL) is charged in a 2 L stainless steel reactor (Brignole, mod. AU-2) and saturated at 60° C. with propylene at a partial pressure p(C₃H₆)=6.0 bar. The polymerization is started by breaking a glass vial containing 94 mg of the catalyst system prepared in example 3 (corresponding to 1.7 mg/3.9 μmol of [Rac-dimethylsisyl-bis(1-Indenyl)Zr(i-Bu)]⁺, Al/Zr mole ratio=8×10²), and allowed to proceed for 1.5 h, after which it is stopped by venting the reactor. The polymer is coagulated in acidified methanol, filtered, washed with further methanol and vacuum-dried. Yield, 3.1 g (corresponding to a productivity of 2.4×10² kg(PP)/[mol(Zr)xmol/L(propylene)xh].

Results of polymer characterization:

### (DSC, on 2^{nd} heating scan) Tₘ=138° C.; Δhₘ=85 J/g.

### (GPC) Mₙ=3.6×10⁴ Da, M_{w}=7.6×10⁵ Da, M_{w}/Mₙ=2.1

### Example 6

### Ethylene/1-butene Copolymerization

A solution of Al(i-Bu)₃ (0.12 mL) in toluene (75 mL) is charged in a 250 mL jacketed Pyrex glass bottle and saturated at 40° C. with an ethylene/1-butene mixture (1.7 mol % 1-butene), bubbling in the liquid phase at a flow of 22 L/h at atmospheric pressure. The copolymerization is started by injecting with a syringe a suspension of the catalyst system prepared in example 3 (90 mg, corresponding to 1.6 mg/3.7 μmol [Rac-dimethylsisyl-bis(1-Indenyl)Zr(i-Bu)]⁺, Al/Zr mole ratio=1.2×10²) in toluene (5 mL), and allowed to proceed for 30 min (without discontinuing the comonomer flow, in such a way that monomer conversion is kept below 20%), after which it is stopped by injecting 10 mL of acidified methanol. The copolymer is coagulated in acidified methanol, filtered, washed with flirter methanol and vacuum-dried. Yield, 3.55 g (corresponding to a productivity of 1.9×10⁴ kg(Cop)/[mol(Zr)xmol/L(monomer)xh]).

### (¹³C NMR) Mole fraction of 1-butene in the copolymer, 7.0%

### (DSC, on 2^{nd} heating scan) Tₘ=100° C.; Δhₘ=38 J/g

(GPC) Mₙ=6.3×10⁴ Da, M_{w}=1.7×10⁵ Da, M_{w}/Mₙ=2.73

1. A catalyst component obtained by contacting:
(a) a solid Lewis acid of formula MR¹ₐ wherein M is a metal of group 1-12 of the Periodic Table of the Elements; R¹ is a fluorine, chlorine, bromine or iodine atom; and a is equal to the valence of the metal M; with
(b) at least one ionic compound of formula (I)
[((T)ₚR²)ₙM^{I}(R³)ₘ]⁻[D]⁺ (I)
wherein:
M¹ is an element belonging to group 13 of the Periodic Table of the Elements;
R³, equal to or different from each other, are halogen atoms, halogenated C₆-C₂₀ aryl or halogenated C₇-C₂₀ alkylaryl groups; two R³ groups can also form with M^{I} a condensed ring;
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or
C₇-C₄₀-arylalkyl radical, optionally containing at least one heteroatom belonging to groups 13-17 of the Periodic Table of the Elements;
the radical R² is substituted with p T groups, wherein T is a Lewis base in its neutral form;
n ranges from 1 to 4; m ranges from 0 to 3; and m+n=4; and
p ranges from 1 to 10; and [D]⁺ is a monovalent cation.

2. The catalyst component according to claim 1 wherein M is a metal of group 2 of the Periodic Table of the Elements.

3. The catalyst component according to claim 1 wherein M^{I} is a boron or aluminium atom and the substituents R³, equal to or different from each other are C₆F₅, C₆F₄H, C₆F₃H₂, C₆H₃(CF₃)₂, perfluoro-biphenyl, heptafluoro-naphthyl, hexafluoro-naphthyl or pentafluoro-naphthyl.

4. The catalyst component according to claim 1 wherein R² is a branched C₁-C₂₀ alkyl, or a C₇-C₂₀ arylalkyl radical, optionally substituted with halogen atoms.

5. The catalyst component according to claim 1 wherein [D]⁺ is a phosphonium, anilinium, ammonium, or a carbenium cation.

6. The catalyst component according to claim 1 wherein T equal to or different from each other is NR⁴₂, PR⁴₂, OR⁴, SR⁴, Si(OR⁴)₃, SiR⁴(OR⁴)₂ or C(O)OR⁴ wherein R⁴ is a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radical, optionally containing at least one heteroatom belonging to groups 13-17 of the Periodic Table of the Elements.

7. The catalyst component according to claim 1 wherein the compound of formula (I) has formula (III): 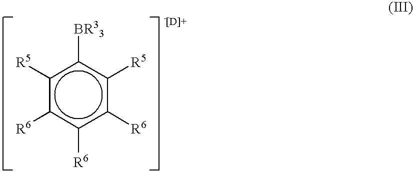
wherein
B is a boron atom;
R⁵, equal to or different from each other, are hydrogen atoms, halogen atoms, or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing at least one heteroatom belonging to groups 13-17 of the Periodic Table of the Elements;
R⁶, equal to or different from each other, have the same meaning of R⁵, or R⁶ is a T group;
provided that at least one R⁶ is a T group.

8. A catalyst system obtained by contacting:
(a) a solid Lewis acid of formula MR¹ₐ wherein M is a metal of group 1-12 of the Periodic Table of the Elements; R¹ is a fluorine, chlorine, bromine or iodine atom; and a is equal to the valence of the metal M;
(b) at least one ionic compound of formula (I)
[((T)ₚR²)ₙM^{I}(R³)ₘ]⁻[D]⁺ (I);
(c) at least a transition metal organometallic compound; and optionally
(d) an organo aluminum compound;
wherein
M^{I} is an element belonging to group 13 of the Periodic Table of the Elements:
R³, equal to or different from each other, are halogen atoms, halogenated C₆-C₂₀ aryl or halogenated C₇-C₂₀ alkylaryl groups: two R³ groups can also form with M^{I} a condensed ring:
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or C₇₋₄₀-arylalkyl radical, optionally containing at least one heteroatom belonging to groups 13-17 of the Periodic Table of the Elements:
the radical R² is substituted with p T groups, wherein T is a Lewis base in its neutral form;
n ranges from 1 to 4; m ranges from 0 to 3 and m+n=4:
p ranges from 1 to 10; and [D]⁺ is a monovalent cation.

9. The catalyst system according to claim 8 wherein the transition metal organometallic compound is a metallocene compound.

10. The catalyst system according to claim 8 wherein the transition metal organometallic compound is a late transition metal complex of formula (V) or (VI)
L^{a}M^{III}X^{a}ₚ^{a} (V)
L^{a}M^{III}A^{a} (VI)
wherein
M^{III} is a metal belonging to Group 8, 9, 10 or 11 of the Periodic Table of the Elements;
L^{a} is a bidentate or tridentate ligand of formula (VII): 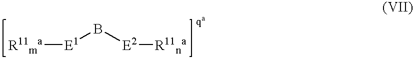
wherein:
B is a C₁-C₅₀ bridging group linking E¹ and E², optionally containing at least one atom belonging to Groups 13-17 of the Periodic Table of the Elements;
E¹ and E², the same or different from each other, are elements belonging to Group 15 or 16 of the Periodic Table of the Elements and are bonded to said metal M^{III};
the substituents R¹¹, equal to or different from each other, are selected from the group consisting of hydrogen, linear or branched, saturated or unsaturated C₁-C₂₀ alkyl, C₃-C₂₀ cycloalkyl, C₆-C₂₀ aryl, C₇-C₂₀ alkylaryl and C₇-C₂₀ arylalkyl radicals, optionally containing at least one atom belonging to groups 13-17 of the Periodic Table of the Elements of the Elements or
two R¹¹ substituents attached to the same atom E¹ or E² form a saturated, unsaturated or aromatic C₄-C₇ ring, having from 4 to 20 carbon atoms;
m^{a} and n^{a} are independently 0, 1 or 2, depending on the valence of E¹ and E², so to satisfy the valence number of E¹ and E²; q^{a} is the charge of the bidentate or tridentate ligand so that the oxidation state of M^{III}X^{a}ₚX^{a}′ₛ or M^{III}A^{a} is satisfied, and the compound (V) or (VI) is overall neutral;
X^{a}, the same or different from each other, are monoanionic sigma ligands selected from the group consisting of hydrogen, halogen, R¹², OR¹², OSO₂CF₃, OCOR¹², SR¹², NR¹²₂ and PR¹²₂ groups, wherein the R¹² substituents are linear or branched, saturated or unsaturated, C₁-C₂₀ alkyl, C₃-C₂₀ cycloalkyl, C₆-C₂₀ aryl, C₇-C₂₀ alkylaryl or C₇-C₂₀ arylalkyl radicals, optionally containing at least one atom belonging to groups 13-17 of the Periodic Table of the Elements of the Elements (new IUPAC notation), or two X^{a} groups form a metallacycle ring containing from 3 to 20 carbon atoms;
p^{a} is an integer ranging from 0 to 3, so that the final compound (V) or (VI) is overall neutral; and
A^{a} is a π-allyl or a π-benzyl group.

11. A process for the preparation of polymers of alpha-olefins comprising contacting at least one alpha-olefin under polymerization conditions in the presence of a catalyst system obtained by contacting:
(a) a solid Lewis acid of formula MR¹ₐ wherein M is a metal of group 1-12 of the Periodic Table of the Elements; R¹ is a fluorine, chlorine, bromine or iodine atom; and a is equal to the valence of the metal M;
(b) at least one ionic compound of formula (I)
(Cp)(ZR⁸ₓ)_{y}(A)ᵣM^{II}L_{w} (I)
(c) at least a transition metal organometallic compound; and optionally
(d) an organo aluminum compound:
wherein
M¹ is an element belonging to group 13 of the Periodic Table of the Elements:
R³, equal to or different from each other, are halogen atoms, halogenated C₆-C₂₀ aryl or halogenated C₇-C₂₀ alkylaryl groups; two R³ groups can also form with M^{I} a condensed ring:
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing at least one heteroatom belonging to groups 13-17 of the Periodic Table of the Elements;
the radical R² is substituted with p T groups, wherein T is a Lewis base in its neutral form,
n ranges from 1 to 4; m ranges from 0 to 3; and m+n=4; and
p ranges from 1 to 10; and [D]⁺ is a monovalent cation.

12. An adduct of formula (II):
(MR¹ₐ)_{q}¹.{[((T)ₚR²)ₙM^{I}(R³)ₘ]⁻[D]⁺}_{q}² (II)
wherein
R¹ is a fluorine, chlorine, bromine or iodine atom; a is equal to the valence of the metal M; M^{I} is an element belonging to group 13 of the Periodic Table of the Elements;
R³, equal to or different from each other, are halogen atoms, halogenated C₆-C₂₀ aryl or halogenated C₇-C₂₀ alkylaryl groups; two R³ groups can also form with M^{I} a condensed ring;
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing at least one heteroatom belonging to groups 13-17 of the Periodic Table of the Elements:
the radical R² is substituted with p T groups, wherein T is a Lewis base in its neutral form,
n ranges from 1 to 4; m ranges from 0 to 3; and m+n=4; and
p ranges from 1 to 10; and [D]⁺ is a monovalent cation;
and the ratio q¹/q² is comprised between 5 and 500.

13. An ionic compound of formula (I):
[((T)ₚR²)ₙM^{I}(R³)ₘ]⁻[D]⁺ (I)
wherein
M^{I} is an element belonging to group 13 of the Periodic Table of the Elements;
R³, equal to or different from each other, are halogen atoms, halogenated C₆-C₂₀ aryl or halogenated C₇-C₂₀ alkylaryl groups; two R³ groups can also form with M^{I} a condensed ring;
R², equal to or different from each other, is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing at least one heteroatom belonging to groups 13-17 of the Periodic Table of the Elements;
the radical R² is substituted with p T groups, wherein T is a Lewis base in its neutral form,
n ranges from 1 to 4; m ranges from 0 to 3; and m+n=4; and
p ranges from 1 to 10; and [D]⁺ is a monovalent cation.

14. The ionic compound according to claim 13 having formula (III)₂ 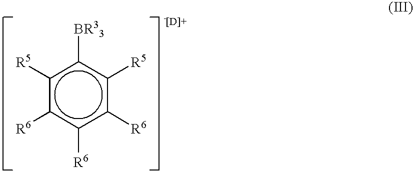
wherein
B is a boron atom;
R⁵, equal to or different from each other, are hydrogen atoms, halogen atoms, or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements;
R⁶, equal to or different from each other, have the same meaning of R⁵ or R⁶ is a T group;
wherein T has the same meaning as in claim 1, provided that at least one R⁶ is a T group.

15. The catalyst component according to claim 1 wherein p ranges from 1 to 5.

16. The catalyst component according to claim 15 wherein p is 1, 2 or 3.

17. The catalyst system of claim 10 wherein in the substituents R¹¹ the at least one atom is B, Al, Si, Ge, N, P, O, S, F and Cl.

18. The catalyst system of claim 10 wherein in the R¹² substituents the at least one atom is B, N, P, Al, Si, Ge, O, S and F.

19. The catalyst system of claim 10 wherein the substituents X^{a} are the same.
